(19) United States
(12) Patent Application Publication
(10) Pub. No.: US 2026/0121773 A1
(43) Pub. Date: Apr. 30, 2026

(54) AUTONOMOUS VEHICLES OPERATING WITH LOW LOCATION SIGNAL STRENGTH

(71) Applicant: Volvo Car Corporation, Gothenburg (SE)

(72) Inventors: Vishisht Dhingra, Göteborg (SE); Mohammad Subhi Mohammad ALQawasmeh, Göteborg (SE); Stefan Järvholm, Hålta (SE); Rubén Calvillo Portales, Göteborg (SE)

(21) Appl. No.: 18/925,459

(22) Filed: Oct. 24, 2024

(51) Int. Cl. H04B 17/318; B60W 50/04; B60W 60/00; H04W 64/00

(52) U.S. Cl. CPC H04B 17/328; B60W 50/04; B60W 60/001; H04W 64/00; B60W 2556/45; B60W 2756/10

(57) ABSTRACT

Various systems and methods are presented regarding utilizing technology onboard a vehicle to mitigate the effects of communication signals being deleteriously affected/lost when operational surroundings cause occlusion/loss of receipt of positioning/location signals at the vehicle. The vehicle can be operating non-autonomously, partially autonomously, or autonomously. To supplement the lost/occluded signals position information of other systems proximate to the vehicle can be obtained/utilized. The other systems can include another vehicle, a mobile device, an internet, and suchlike. Also, onboard devices can be utilized to determine the location, such as an onboard camera system providing information regarding street signs, building facades, and suchlike.

### TECHNICAL FIELD

This application relates to techniques facilitating operation of a vehicle when communications have been compromised as a function of location-provisioning signals are low and/or lost.

### BACKGROUND

Operation of a vehicle, e.g., an autonomous vehicle (AV), can require communications between the vehicle and external systems, such as a Global Navigation Satellite System (GNSS), a Global Positioning System (GPS), a navigation system, a vehicle monitoring system, and suchlike. However, communication(s) between the vehicle and the external system can be compromised, e.g., when the vehicle is being navigated through an area where GPS signals are occluded, where the vehicle can be navigated by a human operator or the AV is operating autonomously. Such compromised operation can lead to a weakening of signal strength or complete loss of signals between the vehicle and the external system(s). Compromising the GPS signal can result in loss of navigation for the vehicle, e.g., safe autonomous operation of the AV cannot be guaranteed, as well as inability to provide status updates regarding events such as a current operating condition of the vehicle, an accident involving the vehicle or detected by the vehicle, a road condition, and suchlike.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to facilitate self-navigation by a vehicle when navigation signals from satellite positioning system are not available.

According to one or more embodiments, a system can be located on a first vehicle navigating a road. The system can comprise a memory that stores computer executable components and a processor that executes the computer executable components stored in the memory. The computer executable components can comprise a signal component configured to determine a signal quality of first navigation signals received at the first vehicle, wherein the first navigation signals are received from a first external system. In a further embodiment, the computer executable components can further comprise a navigation component configured to, in response to determining, by the signal component, the first navigation signals have a signal quality below a signal strength threshold, operate the first vehicle utilizing a second navigation signal received from a second external system.

In an embodiment, the second external system can be located onboard a second vehicle, a mobile device, street infrastructure, an internet node, or a mesh-network node.

In another embodiment, the first external system can be a global positioning system (GPS) utilizing GPS signaling technology and the second external system utilizes signaling technology comprising any of BLUETOOTH®, cellular technology, 3G cellular technology, 4G cellular technology, 5G cellular technology, internet technology, ethernet technology, ultra-wideband, DECAWAVE®, IEEE 802.15.4a standard-based technology, Wi-Fi technology, Radio Frequency Identification technology, short-range communication technology, or near field communication radio technology.

The computer executable components can further comprise a location component further configured to in response to the determination of the first navigation signals have a signal quality below the signal strength threshold, generate a request communication comprising a request for the second external system to provide at least one position relating to a location of the first vehicle. In an embodiment, the signal component can be further configured to transmit the request communication to the second external system.

In an embodiment, the signal quality of the first navigation signals being below the signal strength threshold can be a function of reduction in signal strength of the first navigation signals due to the first vehicle operating in proximity to one or more buildings.

In an embodiment, the second navigation signal can include a location of the first vehicle. The first vehicle can be operating in an autonomous manner.

In another embodiment, the second navigation signal can include a timestamp identifying when the second navigation signal was transmitted and a location of a second vehicle, wherein the second external navigation system can be located onboard the second vehicle.

In a further embodiment, the location component can be configured to determine a distance from the second vehicle, based on a time difference between the timestamp and a time at which the second navigation signal was received at the first vehicle, and based on the location of the second vehicle and the distance from the second vehicle, a location of the first vehicle.

In another embodiment, the second navigation signal can include an image and position data of a building proximate to the first vehicle, whereby the location component can be further configured to identify the location of the building in the image, determine a distance from the building to the first vehicle, and further determine a location of the first vehicle, based on the location of the building and the determined distance between the first vehicle and the building.

In other embodiments, elements described in connection with the disclosed systems can be embodied in different forms such as computer-implemented methods, computer program products, or other forms. For example, in an embodiment, a computer-implemented method can be performed by a device operatively coupled to a processor, wherein the device can be located on a first vehicle, signal quality of first signals received at the first vehicle from a first external system is below a signal quality threshold for acceptable risk of operation of the vehicle, and further switching, by the device, navigation of the vehicle from operation with the first data received from the first external system to operation with second signals comprising second data received from a second external system. In an embodiment, the first external system is a global positioning system (GPS) comprising at least one satellite, and the second external system is located onboard a second vehicle communicatively coupled to the first vehicle.

In an embodiment, the computer-implemented method can further comprise generating, by the device, a request communication, for the second external system to provide at least one position relating to a location of the first vehicle, and transmitting, by the device, the request communication to the second vehicle.

In another embodiment, the computer-implemented method can further comprise receiving, by the device, a first response communication, wherein the response communication comprises at least one of a position of the second vehicle, a position of the first vehicle, a time stamp, a direction of the second vehicle, a direction of the first vehicle, or an image of a structure proximate to the first vehicle.

In another embodiment, the computer-implemented method can further comprise navigating, by the device, the first vehicle, based on at least one of the position of the second vehicle, the position of the first vehicle, the time stamp, the direction of the second vehicle, the direction of the first vehicle, or the image of a structure proximate to the first vehicle.

Further embodiments can include a computer program product comprising a computer readable storage medium having program instructions embodied therewith to enable navigation of a first vehicle. The program instructions are executable by a processor located on the first vehicle, and can cause the processor to monitor signal strength of first signals received at a first vehicle operating in an autonomous manner, wherein the first signals are received from a first external system and are utilized for navigation of the vehicle, determine a drop in the signal strength of the first signals from a first signal strength to a second signal strength, wherein the first signal strength is acceptable for the autonomous operation of the first vehicle based on the first signals and the second signal strength is below a threshold acceptable for the autonomous operation of the first vehicle based on the first signals, and further switch navigation of the first vehicle based on a second signal, wherein the second signal is sourced from a second external system, wherein the first external system is a global positioning system and the second external system is located on a second vehicle communicatively coupled to the first vehicle.

In an embodiment, the second signal can include content comprising at least one of a position of the second vehicle, a position of the first vehicle, a time stamp, a direction of the second vehicle, a direction of the first vehicle, or an image of a structure proximate to the first vehicle.

In another embodiment, the program instructions are further executable by the processor to cause the processor to determine a position of the first vehicle based on the content of the second signal, and navigate the first vehicle based on the determined position of the first vehicle.

In a further embodiment, the program instructions are further executable by the processor to cause the processor to receive a third signal, wherein the third signal is received from one of an intelligent traffic control system, an internet node, a second vehicle, or a mobile device, and further navigate the first vehicle based on content in the third signal.

An advantage of the one or more systems, computer-implemented methods and/or computer program products can be enabling a first vehicle to continue to operate in an autonomous manner while navigation signals may be impaired/below an acceptable signal strength. Other vehicles, systems, etc., can respond to a request for supplemental positioning information from the first vehicle, and in response thereto, can provide the first vehicle with positioning data, images, and suchlike, enabling the first vehicle to self-navigate while navigation signals from a satellite system are sub-par.

### DESCRIPTION OF THE DRAWINGS

One or more embodiments are described below in the Detailed Description section with reference to the following drawings.

FIGS. 1A and 1B illustrate a system comprising various components and devices configured to maintain operation of a vehicle when a navigation signal drops to a potentially unsafe level of operation, in accordance with one or more embodiments.

FIGS. 2A and 2B illustrate various example resources that can be implemented to enable location determination/navigation of a vehicle, in accordance with one or more embodiments.

FIG. 3 illustrates two vehicles in communication with each other, to facilitate position control of a vehicle, in accordance with an embodiment.

FIG. 4 illustrates information exchange between two or more vehicles, in accordance with an embodiment.

FIG. 5 presents a flow diagram for a computer-implemented method for determining whether a vehicle is to go to self-navigating mode based on signal strength, in accordance with at least one embodiment.

FIG. 6 presents a flow diagram for a computer-implemented method for obtaining positioning information from infrastructure located proximate to a road, in accordance with at least one embodiment.

FIG. 7 presents a flow diagram for a computer-implemented method for providing positioning information in response to a positioning request, in accordance with at least one embodiment.

FIG. 8 presents a flow diagram for a computer-implemented method for navigating a vehicle based on an identified structure, in accordance with at least one embodiment.

FIG. 9 illustrates a block flow diagram for a process associated with implementing a second navigation signal in the event of a first navigation signal is below strength, in accordance with an embodiment.

FIG. 10 is a block diagram illustrating an example computing environment in which the various embodiments described herein can be implemented.

FIG. 11 is a block diagram illustrating an example computing environment with which the disclosed subject matter can interact, in accordance with an embodiment.

FIG. 12 presents a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, the Abstract, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer. Px relates to respective location of a vehicle, building, mobile device, infrastructure, and suchlike.

In the various embodiments presented herein, the disclosed subject matter can be directed to utilizing one or more components located on a vehicle, wherein the vehicle can be being operated by a human entity with assistance being provided by position/navigation signals received an external system, (e.g., from a GPS, a GNSS, and suchlike), or the vehicle is an autonomous vehicle (AV) operating in an autonomous manner, wherein the one or more components can be utilized to operate/navigate the vehicle when navigation signals from an external system (e.g., from the GPS) have been lost or are deleteriously impacted. In an embodiment, signals received from various systems, including one or more onboard sensors as well as external systems, can be utilized to replace and/or supplement the navigation signals from the external system having been lost or the signal quality is below a threshold for safe operation of the AV. In an embodiment, while an AV may be operating autonomously, as further described, with the loss of signal quality/strength and a human operator being present in the vehicle, operation of the vehicle can be transferred to the human operator, as required to ensure safe operation.

The various embodiments presented herein can be utilized in any applicable scenario where signal loss can occur, e.g., in a city (e.g., buildings are occluding the signals being transmitted from the external system), a wooded area, mountains, in a tunnel, or any environment where continuity of signal reception is negatively affected/cannot be guaranteed.

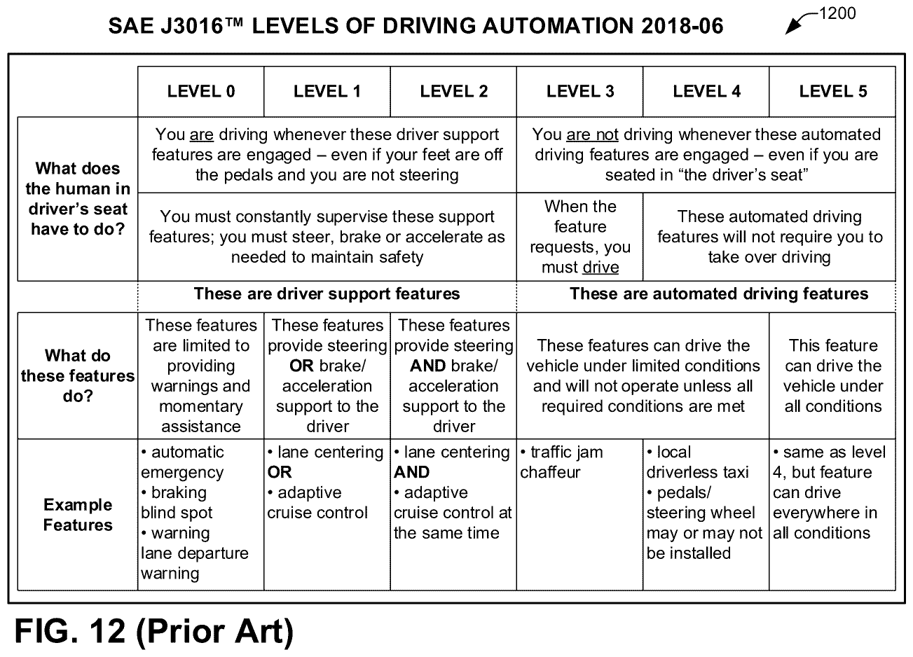

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 12, Table 1200.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls (self-navigates) navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016. In an aspect, autonomous can refer to a vehicle operating in accordance with signals received from a satellite-based positioning system (e.g., GPS) while self-navigating can also involve the vehicle operating autonomously, however, self-navigation can utilize other signals (non-GPS), images, position/location data provided by other systems/vehicles/devices, etc., operating in proximity (e.g., cellular communication range, short distance communications) to the self-navigating vehicle.

It is to be appreciated that while the various embodiments presented herein are directed towards to one or more vehicles (e.g., vehicle 102) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle (e.g., vehicle 102) can be operating in an autonomous manner (e.g., any of Levels 3-5), a partially autonomous manner (e.g., any of levels 1-2), or in a non-autonomous manner (e.g., Level 0), while a second vehicle (e.g., vehicle 270) can also be operating in any of an autonomous manner, a partially autonomous manner, or in a non-autonomous manner.

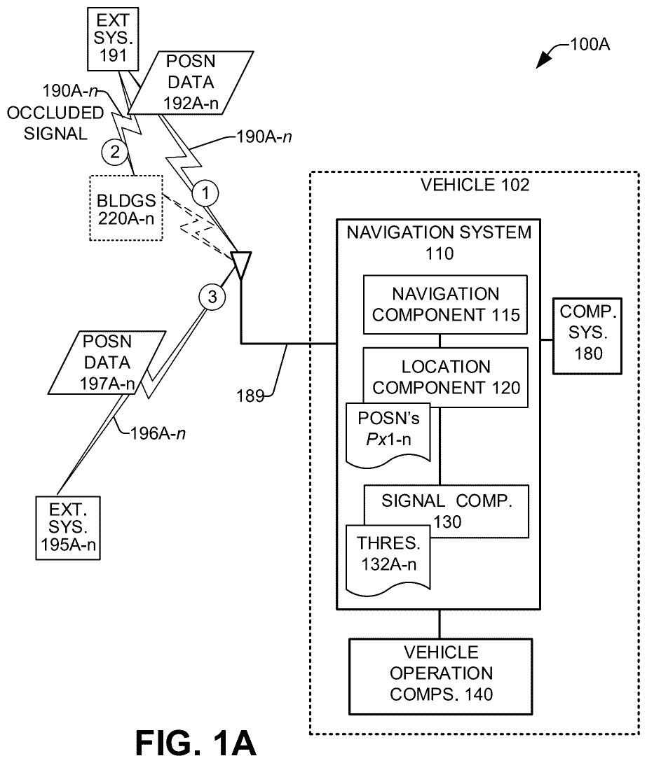

Turning to the drawings, FIGS. 1A and 1B present schematics of systems and components which can be implemented to assist positioning of a vehicle, in accordance with one or more embodiments.

FIG. 1A illustrates a system 100A comprising various components and devices configured to maintain operation of a vehicle when it may not be possible to maintain continuous communications with an external navigation system, in accordance with at least one embodiment.

System 100 comprises a vehicle 102, wherein, per various embodiments presented herein, the vehicle 102 can be operated in any of an autonomous, a semi-autonomous, a “self-navigating”, or a non-autonomous manner. Various devices and components can be located on vehicle 102, such as an onboard computer system 180, as further described. Computer system 180 can be a vehicle control unit (VCU). Computer system 180 can be utilized to provide overall operational control and/or operation of the EV. In an embodiment, computer system 180 can be configured to operate/control/monitor various vehicle operations (e.g., when being operated autonomously, self-navigating, and the like), wherein the various operations can be controlled by one or more vehicle operation components 140 communicatively coupled to the computer system 180, as further described per FIG. 1B.

Vehicle 102 can further include an onboard navigation system 110 comprising various components configured to navigate vehicle 102 along a road, around a city, through a tunnel, etc., as well as to control steering of the vehicle 102. Navigation system 110 can be communicatively coupled to computer system 180. As shown, navigation system 110 can include a navigation component 115 configured to implement one or more navigation operations of vehicle 102. In an embodiment, when vehicle 102 is being operated autonomously, navigation component 115 can have full operational control of the vehicle 102, e.g., controls the velocity of vehicle 102, controls the steering of vehicle 102, controls braking of vehicle 102, etc. During autonomous operation, navigation component 115 can operate in accordance with navigation data/information, e.g., in position information/data 192A-n included in signals 190A-n received from an external system 191A-n. External system 191A can be a GPS data system, a GNSS data system, an autonomous geo-spatial positioning system, a satellite-based positioning, navigation and timing (PNT) system, or other navigation/guidance system.

When vehicle 102 is being operated in a semi-autonomous or non-autonomous manner, navigation component 115 can relinquish a portion, or all, of control of the steering, braking, acceleration, etc., to an occupant (e.g., a driver, not shown) of the vehicle 102. Further, per one or more embodiments presented herein, when vehicle 102 is being operated in an autonomous, semi-autonomous, self-navigating, or non-autonomous manner, navigation component 115 does not have to be 100% reliant on navigation signals 192A-n being received from the external system 191A-n, but rather can supplement or entirely replace navigation data 192A-n typically received from the external system 191A-n with navigation/position data (e.g., position data 192A-n) generated by other systems, devices, components, vehicles, and suchlike.

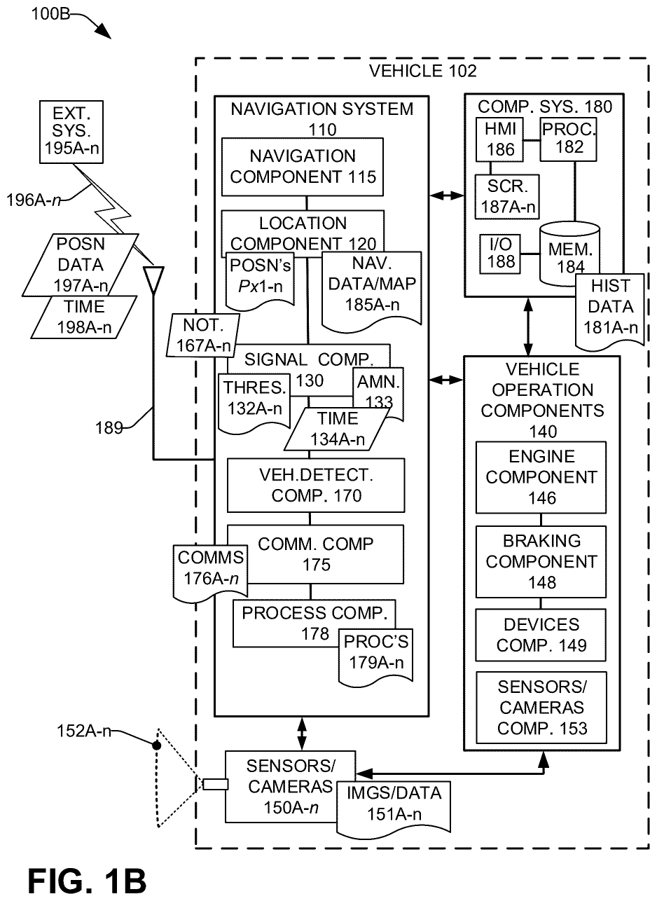

Navigation system 110 can further include a location component 120 which can be configured to utilize the positioning data 192A-n in signals 190A-n to determine a position Px1-n, e.g., regarding a location of vehicle 102, the position can be current (Pcur), prior (Pprior1-n), and/or future (Pfut1-n), e.g., current location Pcur, per FIG. 2A.

Navigation system 110 can further include a signal component 130 configured to scan for/receive, identify, and process the signals 190A-n and position data 192A-n. In an embodiment, signal component 130 can be configured to compare a signal quality/strength of the signals 190A-n with a signal quality/strength threshold 132A-n defined at signal component 130. Signal quality/strength thresholds 132A-n can be configured to assess/measure any suitable parameter, e.g., signal strength, signal quality, signal fidelity, signal integrity, signal continuity, signal packet information, and suchlike, of signals 190A-n.

In the event of the signal component 130 determines the signals 190A-n are above the threshold signal strength 132A-n, sufficient positioning information/data is determined (e.g., by signal component 130) to be being received from the external positioning system 191 for vehicle 102 to be operated in an autonomous manner. In a further embodiment, in the event of signal component 130 determines that the signals 190A-n are at, or below, the threshold signal strength 132A-n, insufficient positioning data 192A-n is determined (e.g., by signal component 130) to potentially be being received from the external positioning system 191 for vehicle 102, with vehicle 102 potentially being operated in a potentially unsafe, catastrophic manner. Accordingly, with the signals 190A-n being at or below threshold signal strength 132A-n, signal component 130 can be configured to initiate one or more operations, components, processes, etc., to supplement signals 190A-n to enable the vehicle 102 to continue to be operated in a safe manner (e.g., “self-navigating” autonomously) based on the first signals 190A-n, second signals 196A-n, and/or digital images/data 151A-n, as further described.

With regard to the steps (1)-(3) presented in FIG. 1, in an aspect, during motion of vehicle 102 through a region, per FIG. 1A (1), ideally, signals 190A-n are received such that a signal strength of the signals 190A-n, and positioning data 192A-n contained in signals 190A-n is sufficient for navigation component 115 to control operation/navigation of vehicle 102 in a safe manner, e.g., particularly when vehicle 102 is being operated in an autonomous manner. However, a situation of operation can occur where the signals 190A-n being received at vehicle 102 are below a desired signal strength threshold 132A-n, and operation of vehicle 102 may be considered to have become unsafe, or approaches unsafe operation. Per FIG. 1A (2), vehicle 102 can be in operation near one or more buildings 220A-n (as further described, per FIG. 2A), with the buildings 220A-n causing occlusion/interruption of the signals 190A-n, such that any signals 190A-n (and included position data 192A-n) that are received at vehicle 102 are below the signal strength threshold 132A-n. Per FIG. 1A (3), as previously mentioned, with the signal component 130 determining signals 190A-n are below signal strength threshold 132A-n, signal component 130 can be configured to utilize a second set of signals 196A-n generated by other sources, second external systems 195A-n. As further described, external systems 195A-n can, in a non-limiting list, comprise other vehicles (e.g., vehicles 270A-n, having an onboard navigation system comparable to navigation system 110), mobile devices (e.g., mobile devices 280A-n), municipal infrastructure (e.g., an intelligent traffic signal 216A-n comprising a computer system 230A-n/positioning system 231A-n), internet systems (e.g., internet nodes 240A-n, mesh-network nodes 242A-n) and suchlike, from which signals 196A-n can be obtained. It is to be appreciated that the various external systems 195A-n presented herein are merely examples of systems that can implement one or more embodiments presented herein, and any suitable system can be utilized. Signals 196A-n can include positioning information 197A-n (aka, second positioning data, supplemental positioning data) which can be utilized to supplement the positioning information/data 192A-n (aka, first positioning data, standard positioning data) in occluded/lost signals 190A-n.

In a further embodiment, with the signal component 130 determining signals 190A-n are below signal strength threshold 132A-n, signal component 130 can be configured to utilize various onboard sensors and cameras 150A-n (per FIG. 1B) to provide supplemental information (e.g., images/data 151A-n) regarding a location (e.g., position Pcur) of vehicle 102, whereby the supplemental information can include street information (e.g., street signs 215A-n), building information (e.g., building numbers 221A-n, building signs 222A-n, building facades, etc.).

Accordingly, the signal component 130 can be configured to obtain/combine supplemental position data 197A-n with the standard position data 192A-n, and further convey the standard position data 192A-n with the supplemental position data 197A-n to the location component 120, wherein the location component 120 can be configured to utilize the standard position data 192A-n with the supplemental position data 197A-n to determine a current, prior, and/or future location P of vehicle 102, particularly where signals 190A-n are below signal strength threshold 132A-n, and operation of vehicle 102 may be unsafe when operating with signals 190A-n below signal strength threshold 132A-n. Position data 192A-n/197A-n provided by signal component 130, and location information generated therefrom by the location component 120, can be utilized by the navigation component 115 to operate vehicle 102.

In a further embodiment, the signal component 130 can be further configured to receive a communication (e.g., communication 176A-n, per FIG. 1B) comprising a request for location assistance from another vehicle (e.g., vehicle 270A, per FIG. 2B). In an embodiment, the location component 120 can be configured to process the request, and as further described, the location component 120 can be configured to further identify a current location Pcur of vehicle 102, and transmit the current location Pcur to vehicle 270A, enabling vehicle 270A to determine a current location of vehicle 270A. Accordingly, two or more vehicles 102/270A-n can provide a network of position information, enabling any of the vehicles to operate autonomously, even though positioning data 192A-n may be compromised/occluded.

As shown in FIG. 1B, system 100B, provides further detail regarding the respective systems, components, devices, etc., presented in FIG. 1A, in accordance with one or more embodiments.

As previously mentioned, a navigation system 110 can be communicatively coupled to a computer system 180. Signal component 130 can be configured to assess signal strength of first signals 190A-n with a signal strength threshold 132A-n, with safe and unsafe operation of vehicle 102 being accordingly determined based thereon. While in a potentially unsafe manner of operation, second signals 196A-n can be obtained from external systems 195A-n, second position data 197A-n is extracted from the second signals 196A-n to enhance the first position data 192A-n. The first position data 192A-n and the second position data 197A-n can be further supplemented/enhanced with images/data 151A-n generated from sensors and/or cameras 150A-n located onboard vehicle 102.

In an embodiment, signals 196A-n can also include a timestamp 198A-n indicating when the signal 196A-n was transmitted. In a further embodiment, the timestamp 198A-n can be compared, e.g., by location component 120, with a current time 134A-n at the vehicle 102, such that a distance from a location of the transmitting system (e.g., any of traffic signal 216A-n, node 240A-n, mesh-network node 242A-n, vehicle 270A-n, mobile device 280A-n, and suchlike, per FIGS. 2A and 2B) to vehicle 102 can be determined. In the event of signals 196A-n (in conjunction with position data 197A-n) are received from numerous external systems 195A-n, the various received signals 196A-n can be triangulated by the location component 120, from which the location P of vehicle 102 can be determined.

As previously mentioned, vehicle 102 can include various vehicle operation components 140. The vehicle operation components 140 can include an engine component 146 configured to control operation, e.g., start/stop, of an engine configured to propel the vehicle 102. The vehicle operation components 140 can further comprise a braking component 148 configured to slow down or stop the vehicle 102. The vehicle operation components 140 can further include a devices component 149 configured to control operation of any onboard devices, e.g., automatic activation of headlights in low-light conditions, when raining, and the like.

The vehicle operation components 140 can further comprise a sensors/camera component 153 configured to control various sensors and/or cameras 150A-n onboard vehicle 102, configured to monitor operation of vehicle 102 and further obtain imagery (e.g., within a field of view/field of detection/sensing region 152A-n of cameras/sensors 150A-n) and other information regarding an operational environment/surroundings of vehicle 102. Digital images/data 151A-n, and suchlike, generated by sensors/cameras 150A-n, can include information/data comprising, in a non-limiting list: any road markings on road 210/211A-n, road signs 215A-n, building numbers 221A-n, building signs 222A-n, façade/exterior of buildings 220A-n, other vehicles 270A-n, etc., wherein, based upon the imagery/sensory data being captured, navigation system 110 can be configured to determine any of a location P, a direction of motion, a velocity, and suchlike, of the vehicle 102. Any suitable technology can be utilized in determining the location/motion of vehicle 102, for example, finite state machine (FSM) architecture.

The sensors/cameras 150A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, microphones, and the like, as employed in such applications as simultaneous localization and mapping (SLAM), and other computer-based technologies and methods utilized to determine an environment being navigated by vehicle 102 and the location P of the vehicle 102 within the operating environment (e.g., location mapping).

Location component 120 can be further configured to analyze the various digital images/data 151A-n, and suchlike, generated by sensors/cameras 150A-n to identify respective features of interest such as a road/street information (e.g., street signs 215A-n, road markings), building information (e.g., building numbers 221A-n, building signs 222A-n, building facades, etc.), other vehicles (e.g., vehicles 270A-n), direction of motion of vehicle 102, and the like.

As further shown, navigation system 110 can further include a communication component 175, wherein the communication component 175 can be configured to interact with any of the external systems 191A-n/196A-n. For example, as further described, communication component 175 can be configured to generate, receive, and/or process respective communications 176A-n, between vehicle 102 and any of the external systems 191A-n/196A-n. A communication 176A-n can be any of a request for positioning information, a response including positioning information, an instruction, confirmation, etc.

Navigation system 110 can further comprise a process component 178, wherein the process component 178 can be configured to implement various processes 179A-n. Processes 179A-n can be utilized to determine information, make predictions, etc., regarding any of the road being navigated, surrounding environment, location of any of vehicles 102/270A-n, mobile devices 280A-n, nodes 240A-n/242A-n, traffic signals 216A-n, buildings 220A-n, signal strength of communications between vehicle 102 and an external system, and suchlike. Processes 179A-n can include a computer vision algorithm(s), a digital imagery algorithm(s), position prediction, velocity prediction, motion prediction, and suchlike, to enable the respective determinations, predictions, etc., per the various embodiments presented herein.

In an embodiment, the location component 120, in conjunction with the process component 178/processes 179A-n, can be configured to compare the digital images/data 151A-n with navigation images/data 185A-n, wherein the navigation images/data 185A-n can include any of the road/street information (e.g., street signs 215A-n, road markings), building information (e.g., building numbers 221A-n, building signs 222A-n, building facades, etc.), direction of motion of vehicle 102, and the like, wherein the navigation data 185A-n has been previously obtained, e.g., captured during prior operation of vehicle 102, provided by external navigation systems/digital mapping systems, satellite imagery, aerial photography, street maps, 360° interactive panoramic views of streets, route planning applications, and suchlike. Accordingly, by comparing digital images/data 151A-n with navigation images/data 185A-n, it is possible for the location component 120 to infer/determine a location P of vehicle 102. In an example of use of vehicle 102, vehicle 102 may be frequently driven along a particular route, e.g., vehicle 102 is a delivery vehicle, a private vehicle, a ride-share vehicle, taxi, and suchlike. Accordingly, imagery/data 151A-n of the route can be captured during the prior operation(s) of vehicle 102. In another embodiment, as further described, a vehicle (e.g., vehicle 270A) can capture imagery/data 151A-n in real-time to assist location/positioning of vehicle 102.

As mentioned, thresholds 132A-n be utilized to control vehicle 102 operating in an autonomous/semi-autonomous manner. Based upon whether the signal strength of signals 190A-n has dropped below the threshold 132A of acceptable signal quality or not, the signal component 130 can be configured to generate an autonomous mode notification (AMN) 133, wherein the AMN 133 can respectively indicate whether the vehicle 102 is to operate in an autonomous manner, a self-navigating mode, vehicle 102 should pullover (if possible) and stop, etc. The AMN 133 can be transmitted to the navigation component 115 instructing the navigation component 115 to operate the vehicle 102 autonomously, requires assistance from an occupant of the vehicle 102, etc. In an embodiment, in the event that vehicle 102 is being operated in a non-autonomous manner (e.g., Level 0 of SAE J3016), operation of the signal component 130 can be configured to generate notifications 167A-n to be utilized to present a warning on the HMI 186/screen 187A-n to notify the driver of vehicle 102 of the loss of signals 190A-n being received by the vehicle 102.

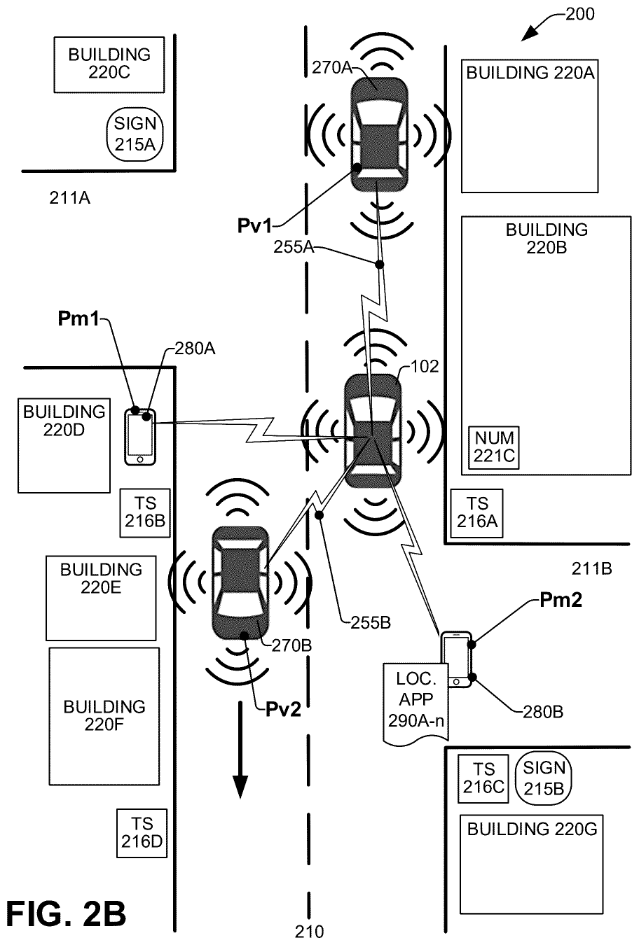

Navigation system 110 can further include a vehicle detection component (VDC) 170 which can be configured to identify a presence and monitor operation (e.g., motion, direction) of another vehicle/second vehicle (e.g. vehicle 270A-n), that is also navigating/parked on the road 210/211A-n being navigated by first vehicle, vehicle 102. Vehicle 270A-n can be operating autonomously, semi-autonomously, or non-autonomously. In an embodiment, vehicle 270A-n can include a navigation system, computer system, vehicle operation components, sensors/cameras, and suchlike, comparable to those described herein regarding vehicle 102, hence, operations/processes (e.g., signal processing, navigation, communications, and suchlike) performed by vehicle 102 can be equally performed by vehicle 270A-n. In an embodiment, vehicle 102 can interact with vehicle 270A-n such that position data 192A-n received at vehicle 270A can be forwarded to vehicle 102, wherein vehicle 270A functions as a pass-through system for vehicle 102 to communicate with external system 191. In another embodiment, vehicle 270A may have communications with the external system 191 and/or external system(s) 195A-n, wherein the second vehicle 270A can be configured to provide positional information 197A-n (e.g., navigation data 192A-n received at second vehicle 270A from the external system 191) to vehicle 102, thus enabling vehicle 102 to self-navigate road 210/211A-n assisted by position information 197A-n received from the second vehicle 270A. In an embodiment, vehicle 270A-n can be configured with communication technology enabling communication between vehicle 270A-n and vehicle 102 (e.g., to facilitate transmission of position data 197A-n/communications 176A-n therebetween). In an embodiment where a VDC 170B-n is located on vehicle 270A-n, VDC 170B-n can be utilized to identify vehicle 102, and further supplement a determination of a location P of vehicle 102, e.g., based on content provided in a request communication (e.g., content 410 in request communication 176A, per FIG. 4).

As shown in FIG. 1B, computer system 180 can be communicatively coupled to/included in the navigation system 110. Computer system 180 can include a memory 184 that stores the respective computer executable components (e.g., navigation component 115, location component 120, signal component 130, vehicle detection component 170, communication component 175, process component 178, engine component 146, braking component 148, devices component 149, and sensor/camera component 153, and suchlike.) and further, a processor 182 configured to execute the computer executable components stored in the memory 184. Memory 184 can be further configured to store/include signals 190A-n, first position data 192A-n, signals 196A-n, second position data 197A-n, positions Px1-n, thresholds 132A-n, AMN 133, images/data 151A-n, navigation data 185A-n, information regarding any of signs 215A-n, traffic signals 216A-n, buildings 220A-n, building numbers 221A-n, building signs 222A-n, internet nodes 240A-n, mesh-network nodes 242A-n, vehicles 270A-n, and mobile devices 280A-n, field of view/field of detection/sensing region 152A-n, and further, historical data 181A-n, wherein historical data 181A-n can include any previously/current/future defined/identified/processed signals 190A-n, first position data 192A-n, signals 196A-n, second position data 197A-n, positions Px1-n, thresholds 132A-n, AMN 133, images/data 151A-n, navigation data 185A-n, information regarding any of signs 215A-n, traffic signals 216A-n, buildings 220A-n, building numbers 221A-n, building signs 222A-n, internet nodes 240A-n, mesh-network nodes 242A-n, vehicles 270A-n, and mobile devices 280A-n, field of view/field of detection/sensing region 152A-n, and suchlike.

In an embodiment, the vehicle operation components 140 can form a standalone component communicatively coupled to the computer system 180, and while not shown, the vehicle operation components 140 can operate in conjunction with a processor (e.g., functionally comparable to processor 182) and a memory (e.g., functionally comparable to memory 184) to enable navigation, steering, braking/acceleration, etc., of vehicle 102 to a destination. In another embodiment, the vehicle operation components 140 can operate in conjunction with the processor 182 and memory 184 of the computer system 180, wherein the various control functions (e.g., navigation, steering, braking/acceleration) can be controlled by the computer system 180.

Similarly, the navigation system 110 can form a standalone component communicatively coupled to the computer system 180, and while not shown, the navigation system 110 can operate in conjunction with a processor (e.g., functionally comparable to processor 182) and a memory (e.g., functionally comparable to memory 184) to enable safe operation when loss/degradation of signals 190A-n is occurring, e.g., during operation of vehicle 102. In another embodiment, the navigation system 110 can operate in conjunction with the processor 182 and memory 184 of the computer system 180, wherein the various signal-loss related functions can be controlled by the computer system 180. In a further embodiment, the computer system 180, vehicle operation components 140, and the navigation system 110 (and respective sub-components) can operate using a common processor (e.g., processor 182) and memory (e.g., memory 184).

The computer system 180 can further include a human machine interface (HMI) 186 (e.g., a display, a graphical-user interface (GUI), infotainment system) which can be configured to present various information regarding any of signals 190A-n, first position data 192A-n, signals 196A-n, second position data 197A-n, positions Px1-n, thresholds 132A-n, AMN 133, images/data 151A-n, navigation data 185A-n, information regarding any of signs 215A-n, traffic signals 216A-n, buildings 220A-n, building numbers 221A-n, building signs 222A-n, internet nodes 240A-n, mesh-network nodes 242A-n, vehicles 270A-n, and mobile devices 280A-n, field of view/field of detection/sensing region 152A-n, and further, historical data 181A-n, etc., per the various embodiments presented herein. HMI 186 can include an interactive display 187A-n to present the various information via various screens presented thereon, and further configured to facilitate input of information/settings/selections, etc., regarding operation of the vehicle 102.

As further shown, the computer system 180 can include an input/output (I/O) component 188, wherein the I/O component 188 can be a transceiver configured/communicatively coupled to enable transmission/receipt (via antenna 189) of signals 190A-n/196A-n, position information 192A-n/197A-n, communications 176A-n, and suchlike, between the navigation system 110/computer system 180 and any external system(s) 191/195A-n. Any suitable technology can be utilized to enable the various embodiments presented herein, regarding transmission and receiving of signals 190A-n/196A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like. Signaling technology between external system 191 (e.g., GPS satellites) and vehicle 102 (and vehicles 270A-n) can utilize GPS signals having frequencies L1 1575.42 MHz and L2 1227.60 MHz.

FIGS. 2A and 2B present schematics illustrating vehicle 102 interacting with various systems, devices, etc., to assist positioning of vehicle 102. FIGS. 2A and 2B can be combined, indicating the various systems, devices, etc., vehicle 102 can be interacting with at any given time, e.g., to enhance position determination.

FIG. 2A, schematic 200A, illustrates various example resources that can be implemented to enable location determination/navigation of a vehicle, in accordance with one or more embodiments presented herein.

As shown, a first vehicle, vehicle 102, can be progressing along a road 210 (aka, a street, thoroughfare, and suchlike), whereby other roads 211A-n intersect with road 210. At respective junction(s) of road 210 with roads 211A-n, street infrastructure such as street signs 215A-n, traffic signals 216A-n, etc., can be located. Buil-nngs 220A-n can also be positioned alongside the road 210 and roads 211A-n. Buildings 220A-n can be of any size (e.g., as found in a city, conurbation, rural areas, and suchlike), whereby the respective heights of respective buildings 220A-n can be such that the buildings 220A-n can act to occlude location signals 190A-n received from external system 191. Buildings 220A-n can also have street numbers 221A-n on their exterior, in conjunction with a business/residence name/sign 222A-n and further, the exterior of buildings 220A-n may be sufficiently unique to enable determination of the respective building 220A-n, based on, for example, a collection of building images (e.g., in images 151A-n, historical data 181A-n, and suchlike) pertaining to a region (e.g., in a city, state, country) currently being driven by vehicle 102.

In an embodiment, the various onboard sensors/cameras 150A-n and sensor/camera component 153 can be utilized to capture information from the street signs 215A-n, building numbers 221A-n, building names 222A-n, etc. Character recognition of the street signs 215A-n and building numbers 221A-n can be performed by location component 120 to determine the name of the road 210 being navigated, and any crossroads/intersections 211A-n. Similarly, character recognition can be performed to determine, from signs 222A-n, an occupier of a building 220A-n, which can also be used to determine a location of the building 220A-n/vehicle 102.

As technology becomes further included in the infrastructure of towns, cities, conurbations, etc., navigation system 110 can be further configured to take advantage of such technology infrastructure. For example, intelligent traffic signals 216A-n can be configured to respectively include a control system 230A-n, whereby the control system 230A-n can include a positioning system 231A-n transmitting/receiving signals 232A-n that can be utilized as part of controlling operation/switching of the traffic signals 216A-n. Signals 232A-n can include positioning information (e.g., GPS data) identifying respective location (Pt) of respective traffic signals 216A-n. Further, vehicles 235A-n (e.g., a snow plow for a municipality, emergency vehicle, and suchlike) can be configured to control operation of the traffic signals 216A-n to enable the vehicle 235A-n to proceed through the traffic signal 216A-n without stopping. Accordingly, the traffic signal operation signals 232A-n used as part of controlling operation of the traffic signal 216A-n can be captured/received at the vehicle 102 (e.g., by the navigation component 115) and further processed to identify/extract the location information of the traffic signal 216A-n. It is to be appreciated that any computer-based system having an operation comparable to traffic signals 216A-n can be utilized, wherein other comparable systems can include digital road/highway signs (e.g., programmable warning signs), digital billboards, etc., which can include geolocation information.

As further shown, businesses, private residences, government entities, and suchlike, commonly have some form of internet/wi-fi 240A-n operating on the premises. Also, a premises can have a mesh-network 241 operating, whereby the mesh-network 241 can comprise of a set of nodes 242A-n located across the premises. In an aspect, one or more of the nodes 242A-n can comprise/form one or more components, aka, internet of things (e.g., doorbell camera, room thermostat, lighting control system, and suchlike). The internet 240A-n/nodes 242A-n can be further configured to transmit one or more signals 248A-n, whereby the one or more signals 248A-n can include a position identifier Pn1-n of the internet 240A-n/nodes 242A-n. Accordingly, the position identifier Pn1-n can be captured/received at the vehicle 102 (e.g., by the location component 120) and further processed to identify the location Pn1-n of the internet 240A-n/nodes 242A-n. In an embodiment, a node 240A-n/242A-n can be configured such that the geolocation of the node 240A-n/242A-n is known. Any suitable technology/technique can be utilized to provide the geolocation of node 240A-n/242A-n. In a non-limiting list, such suitable techniques can include a geolocation of latitude/longitude (e.g., GPS location) determined for a node 240A-n/242A-n associated with any of the internet-protocol (IP) address, domain name server (DNS) address, and suchlike, whereby the geolocation can be provided by any of (a) physical geolocation device communicatively coupled to the node 240A-n/242A-n, (b) geolocation information obtained from one or more actions such as geolocation being implemented as part of conducting e-commerce, e.g., location is based as part of a billing/delivery process, (c) geolocation derived from a device communicatively coupled to the node 240A-n/242A-n, whereby position of the device is known based on cellular/GPS signaling/communications conducted with the device, and suchlike.

As shown in FIG. 2A, a location application 290A-n can be respectively installed at any of the various systems, networks, etc. In an embodiment, the location application 290A-n can be implemented at the respective system, and configured to respond to a position request communication 176A-n generated by communication component 175. Location application 290A-n can be implemented at the respective system, e.g., by a processor, memory, and I/O component operating at each system, network, etc., wherein while the respective processor, memory, and I/O components are not shown in FIGS. 2A and 2B, the respective processor, memory, and I/O components can be comparable in operation to processor 182, memory 184, I/O component 188. The respective systems implementing location application 290A-n can include any of the street infrastructure (e.g., traffic signal 216A-n), network system (e.g., on internet node 240A-n, mesh-network node 242A-n), on a mobile device (e.g., mobile device 280A-n), and suchlike. As previously mentioned, the respective system implementing location application 290A-n can be configured with a geolocation identifier providing a respective position Px of the respective system/device. Accordingly, in response to receiving a position request communication 176A from vehicle 102, the respective system/device can respond with the position/location Px of the system/device. Accordingly, any of the locations Pt1-n (traffic signals 216A-n), Pb1-n (buildings 220A-n), Ps1-n (nodes 240A-n, 242A-n), Pv1-n (vehicle 270A-n), Pm1-n (mobile device 280A-n), and suchlike, can be utilized to infer/determine position P (e.g., Pcur, Pcuror, Pfut) of vehicle 102.

FIG. 2B, schematic 200B, illustrates various vehicles and mobile devices interacting with a vehicle, to enable positioning/navigation of the vehicle, in accordance with one or more embodiments presented herein. As further shown in FIG. 2B, other vehicles 270A-n can also be being driven/parked on roads 210/211A-n. In embodiment, the vehicles 270A-n can also be transmitting signals 255A-n which can include positioning information/position data 197A-n.

In an embodiment, the first vehicle 102 can be undergoing loss of GPS signal, while one or more of vehicles 270A-n can be receiving a GPS signal with a signal strength above threshold 132A-n.

In another embodiment, one or more mobile devices 280A-n can be in operation/active in the vicinity of vehicle 102, wherein the mobile devices 280A-n can be a cellular phone, a portable computer, a laptop computer, a tablet computer, and suchlike. The one or more mobile devices 280A-n can be being carried/operated by any entity proximate to vehicle 102, such as a pedestrian, a cyclist, a person on a nearby vehicle 270A-n, a person in a nearby building 220A-n, and suchlike. In an embodiment, with a mobile device 280A-n being operated concurrently with cellular data (and associated GPS data/triangulation), the location of the mobile device 280A-n can be known. Accordingly, vehicle 102 can interact with the mobile device 280A-n, and use the location knowledge of the mobile device 280A-n to assist the location component 120 in determining location of the vehicle 102. In an embodiment, mobile device 280A-n can be located onboard the vehicle 102, such that the signal component 130 and location component 120 can utilize position data 197A-n generated by the mobile device 280A-n (and received in signals 196A-n) to determine location P of vehicle 102.

In an embodiment, vehicle 102 can utilize the other vehicle 270A-n to act as a proxy/go-between between vehicle 102 and the external system 191. Accordingly, where the other vehicle 270A-n has communication with the external system 191, the vehicle 270A-n can be configured to receive and forward positioning data 192A-n to/from external system 191 to/from vehicle 102.

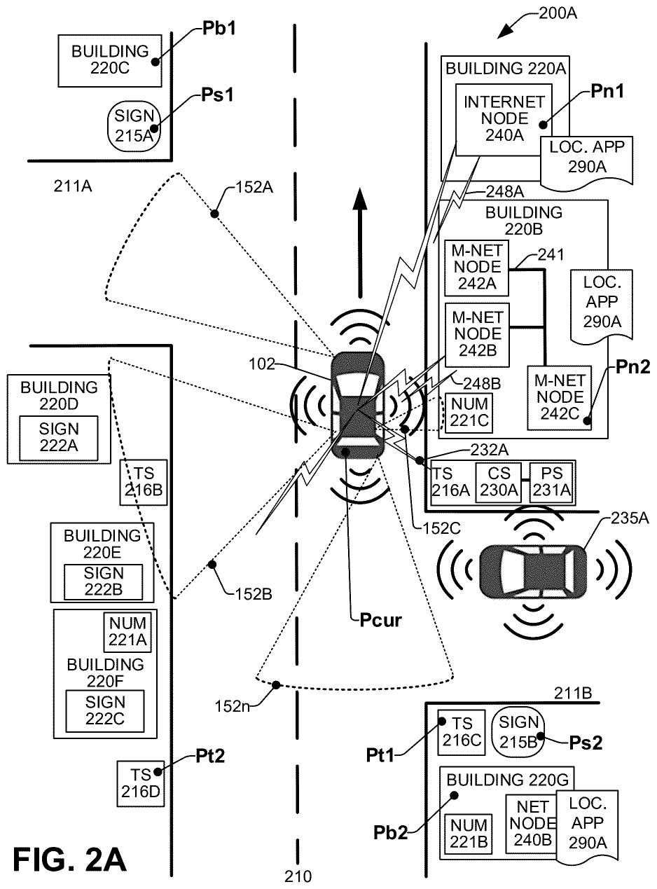

FIG. 3, schematic 300, illustrates two vehicles in communication with each other, to facilitate position control of a vehicle, in accordance with an embodiment.

Vehicles 102 and 270A can include comparable onboard systems, enabling functionality at vehicle 102 to be implemented on vehicle 270A. As shown, vehicle 270A can function as an external system 195A (e.g., second external system).

At (1), in an embodiment, vehicle 270A is in communication with first external system 191 with signals 190A-n and position data 192A-n being received at vehicle 270A (e.g., at a signal component 130B). Signals 190A-n are not available, or of poor signal quality, at vehicle 102, accordingly, vehicle 270A has knowledge of its location, while vehicle 102 does not.

At (2), vehicle 102 can generate a request communication 176A requesting any vehicles 270A-n in vicinity of vehicle 102 to provide vehicle 102 with positioning data. Request communication 176A can be generated by signal component 130A, and include a timestamp 134A, vehicle identifiers, etc., and transmitted in a signal 196A.

At (3), vehicle 270A can receive the request (e.g., via signal component 130B). In an embodiment, location component 120B can utilize timestamp 134A to infer/determine a location of vehicle 102 when the request communication was transmitted. In response, vehicle 270A can generate a response communication 176B (e.g., by communication component 175B in conjunction with signal component 130B and location component 120B), wherein the response communication 176B can include a position of vehicle 270A, identifying information regarding vehicle 270A, a timestamp 134B, inferred location of vehicle 102, and suchlike. In a further embodiment, vehicle 270A can further include in response communication 176B one or more images/data 151B pertaining to a sign 215A-n, traffic signal 216A-n, building 220A-n, building number 221A-n, building sign 222A-n, and suchlike, in conjunction with position information pertaining to the respective sign, etc., whereby the images/data 151B can be utilized by vehicle 102 to further determine location of vehicle 102. In an embodiment, images/data 151B can be captured immediately by sensors/cameras 150B regarding vehicle 102's location, and any identified buildings, etc., can be tagged with position information. In another embodiment, navigation images/data 185B can be retrieved pertaining to location of vehicle 102, and transmitted as images/data 151B in conjunction with respective position information.

At (4), vehicle 270A can transmit the response communication 176B to vehicle 102, via signal 196B.

At (5), upon receipt of the response communication 176B, vehicle 102 can utilize the content of the response communication 176B to determine a location of vehicle 102, e.g., based on location of vehicle 270A, inferred location of vehicle 102, direction, distance, time stamp information, and suchlike. Location component 120A can further process any received images/data 151B and associated position information, such that location component 120A can determine a position of vehicle 102 based on the respective buildings 220A-n, etc., in images/data 151B. Location component 120A, in conjunction with camera/sensor component 153A, can control operation of sensors/cameras 150A such that vehicle 102 can navigate based on the buildings 220A-n, etc., in field of view 152A. Hence, while vehicle 102 is unable to receive position data 192A-n from the first external system 191, vehicle 102 can utilized position data 197A-n, etc., received from vehicle 270A, wherein vehicle 270A is effectively functioning as a second external system 195A-n.

FIG. 4, schematic 400, illustrates information exchange between two or more vehicles, in accordance with an embodiment.

As shown, in response to a determination by the signal component 130 that the signal strength threshold 132A-n for the signals 190A-n is approaching, is at, or is below a threshold 132A-n, navigation component 115 can be further configured to generate and transmit a request, in communications 176A-n, for assistance in determining location of vehicle 102. The request communication 176A can be transmitted for reception by other vehicles 270A-n local to vehicle 102. The request can comprise of any suitable information to enhance/supplement location determination of vehicle 102. Content 410 presents example information that can be included in request communication 176A, for example, information that can aid identification of vehicle 102, such as vehicle model, license plate information, vehicle identifier such as vehicle identification number (VIN), color, and suchlike, in conjunction with a status “undergoing vehicle positioning issue”, a request to one or more receiving vehicles 270A-n, to provide any of an identifier (e.g., a VIN), current location Pcur, relative distance/direction from vehicle 270A-n to vehicle 102, and suchlike.

In response to receiving the request communication 176A, a navigation system 110B onboard vehicle 270A can be configured to generate and transmit a response communication 176B comprising content 420. Content 420 pertaining to vehicle 270A can include vehicle model, license plate, identifier (e.g., VIN), color, etc. Content 420 can also include position data 197A comprising a current position Pn1 (e.g., latitude and longitude) of vehicle 270A, in conjunction with other information such as the street name of the road 210 (e.g., Cleveland Street) being navigated by vehicle 270A, street address/building number 221A-n (e.g., #76) and name 222A-n (e.g., Sandra's Deli) of one or more buildings 220A-n proximate to vehicle 270A, and further, a distance (e.g., 10 meters) and direction (e.g., behind vehicle 102, with vehicle 270A driving north). Content 420 can further include a time stamp (e.g., time 12:00:00:00 for time stamp 134A), and if available, images/data 151B regarding buildings 220A-n, signs 215A-n, etc., pertaining to the location of vehicle 102. The distance and direction information of vehicle 270A from vehicle 102 can be determined by any suitable process/technology, e.g., transmission/time-of-flight data of communications 176A-n between vehicle 102 and vehicle 270A, visual location of vehicle 102 by the sensors/cameras 150B/sensor/camera component 153B, vehicle detection component 170B, and suchlike, on vehicle 270A based on the identification information provided by vehicle 102 in content 410.

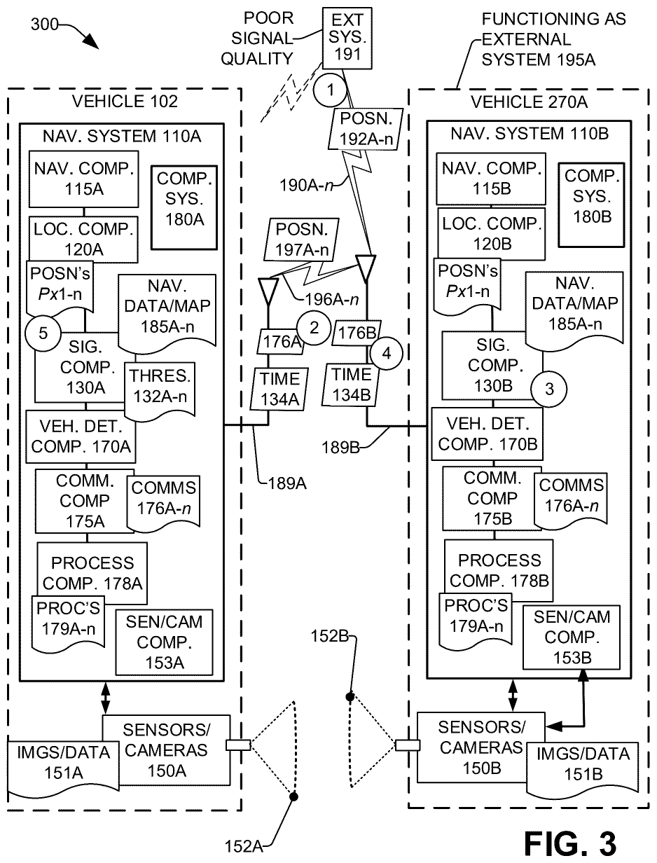

Repeated communications 176A-n can occur between vehicle 102 and vehicle 270A for the duration of signals 190A-n and positioning data 192A-n from the first external system 191 is determined to be at, or below, a threshold 132A implemented at the signal component 130A onboard vehicle 102, for example, as further described per FIG. 5, method 500. Further, with more than one vehicle 270A-n responding to request communication 176A, and the corresponding response communications 176B-n being generated and transmitted to vehicle 102, and the respective content 420A-n in the response communications 176B-n from the respective vehicles 270A-n, position determination P by location component 120A on vehicle 102 can be further enhanced in accordance with the volume/plethora of position-related information provided in content 420A-n.

FIG. 5 presents a flow diagram 500 for a computer-implemented method for determining whether a vehicle is to go to self-navigating mode based on signal strength, in accordance with at least one embodiment.

At 510, a signal threshold (e.g., threshold 132A-n) can be configured (e.g., at signal component 130) regarding a quality of first navigation signals (e.g., signals 190A-n and positioning data 192A-n) received from a first external system (e.g., external system 191A-n) and an ability of a vehicle (e.g., vehicle 102) to safely operate autonomously. As previously described, if a signal quality is above the threshold, it is considered that the risk of the vehicle having an accident/losing control has an acceptable level of risk. Further, if the signal quality drops below the threshold, then the risk can become unacceptable regarding potential for an accident/losing control.

At 520, the first signals received at the vehicle from the first external system can be monitored (e.g., by the signal component 130 operating in accordance with the computer system 180, the antenna 189, I/O component 188, and the like).

At 530, in response to a determination (e.g., by signal component 130) that NO, the received first signals are not below threshold, methodology 500 can advance to 540 where the vehicle continues to operate in an autonomous manner, e.g., navigation is based in part on the first signals received from the first external system. Methodology 500 can further return to 520 for further monitoring of first signals received from the first external system.

Returning to 530, in response to a determination that YES the received first signals are below threshold, methodology 500 can advance to 550 where the vehicle can be configured to operate autonomously but in a self-navigating mode. In an embodiment, as mentioned herein, the quality and reliability of the signals can be deleteriously affected as a function of loss of signal in a city, a rural area, in a mountainous region, and suchlike. At 550, the first vehicle can be configured to operate in a “self-navigating” manner, wherein the first vehicle can switch operations from relying on the various signals (aka first signals) received from the first external system, and rather, navigates using data and information (aka second signals 197A-n) received from a second external system (e.g., external system 195A-n) comprising any of a second vehicle (e.g., vehicle 270A-n), from an internet node (e.g., internet nodes 240A-n), from a mesh-network node (e.g., from mesh-network node 242A-n), from city infrastructure (e.g., traffic signal 216A-n), and/or images/data (e.g., images/data 151A-n) compiled from onboard sensors/cameras (e.g., sensors/cameras 150A-n).

Methodology 500 can return to 520 for subsequent determination of whether the vehicle can safely return to autonomous operation (e.g., first signals are above threshold signal strength/quality), or the vehicle is to maintain self-navigating operation.

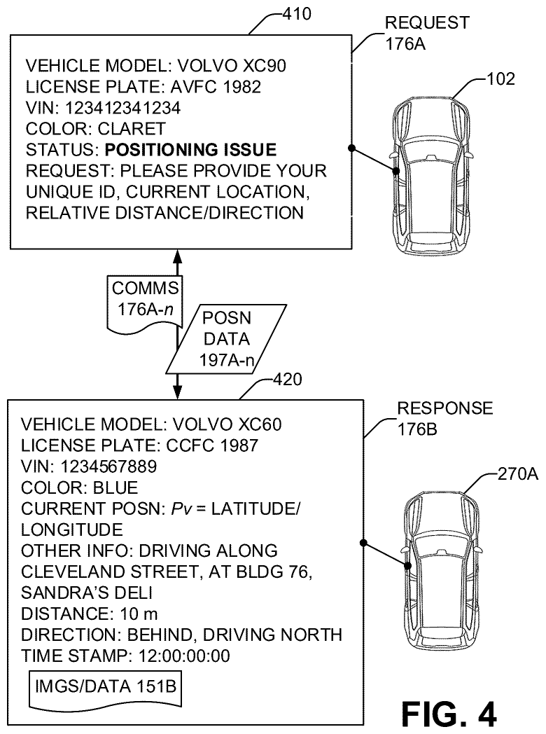

FIG. 6 presents a flow diagram 600 for a computer-implemented method for obtaining positioning information from infrastructure located proximate to a road, in accordance with at least one embodiment.

At 610, a vehicle (e.g., vehicle 102) can undergo loss of/diminished signal strength for navigation signals (e.g., position data 192A-n in signals 190A-n) received from a first navigation system (e.g., first navigation system 191).

At 620, in response to a determination that the signal strength is below a threshold (e.g., threshold 132A) the vehicle can be placed in self-navigate mode (as previously described in FIG. 5).

At 630, the vehicle can be configured to receive/intercept a signal (e.g., signals 196A-n), whereby the signal can be received/intercepted by a signal component (e.g., signal component 130) located onboard vehicle 102. In an embodiment, the signal can be configured with a time stamp (e.g., timestamp 134A-n) at which the signal was transmitted.

At 640, the vehicle can be further configured to identify street infrastructure (e.g., a traffic signal 216A functioning as a second external system 195A) that generated the received signal. It is to be appreciated that the signal can also be generated in response to a request communication (e.g., request communication 176A-n) transmitted from the vehicle, and processed by a location application (e.g., location application 290A-n) implemented at the street infrastructure.

At 650, a determination can be made (e.g., by signal component 130) regarding whether the signal includes position data that the vehicle can utilize to assist the self-navigating operation. In response to a determination of NO, the received signal does not include useable position data, method 600 can return to step 630, for another signal to be received/intercepted (or request communication 176A-n generated and transmitted).

At 650, in response to YES, the signal does include position data (e.g., position data 197A-n), method 1000 can advance to 660, whereupon the position data can be extracted from the received signal (e.g., by signal component 130).

At 670, the extracted position data can be utilized to infer the position of the vehicle. For example, the street infrastructure has a known geolocation (e.g., GPS latitude/longitude), whereby the position data can be provided to a location component (e.g., location component 120) from which the location of the vehicle can be inferred from the street infrastructure (e.g., location component 120 can utilize time of flight technology between when the signal was generated and transmitted from the traffic signal 216A) and the location of the vehicle relative to the street infrastructure.

It is to be appreciated that while FIG. 6 references signals 196A-n being generated by, and intercepted from, a traffic signal 216A-n, signals 196A-n can be generated by, and received from, a range of second external systems 195A-n, including internet nodes 240A-n, mesh-network nodes 242A-n, vehicles 270A-n, mobile devices 280A-n, and suchlike. And as previously mentioned, by knowing the location (e.g., GPS latitude/longitude in position data 197A-n) of the respective transmitting system, the distance to vehicle 102 can be inferred/determined, with the transmitting system being used as a base point against which further navigation of vehicle 102 can be based.

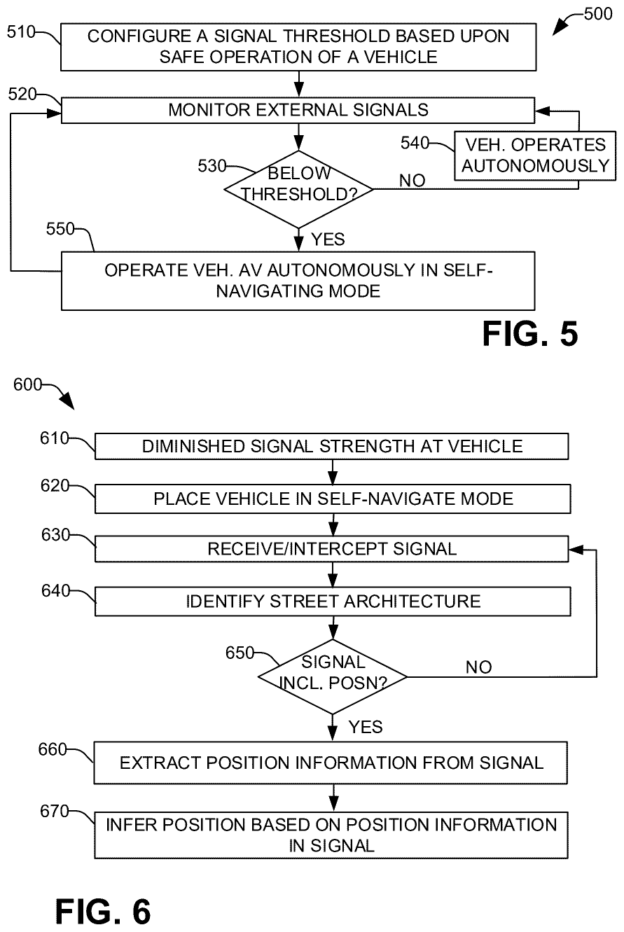

FIG. 7 presents a flow diagram 700 for a computer-implemented method for providing positioning information in response to a positioning request, in accordance with at least one embodiment.

At 710, a request communication (e.g., request communication 176A) can be received (e.g., at vehicle 270A) from a vehicle (e.g., vehicle 102), wherein the vehicle may be undergoing navigation issues owing to navigation signals received at the vehicle being of poor quality. The request communication can include content enabling the requesting vehicle to be identified, e.g., VIN number, or other identifier, make/model, colour, etc. (e.g., per FIG. 4). The content can further include a first timestamp from which distance to the vehicle can be determined. The request communication can be received at any of another vehicle (e.g., vehicle 270A-n, a mobile device 280A-n, an intelligent traffic signal 216A-n, a node 240A-n/242A-n, a device having a location application 290A-n implemented thereon, and suchlike).

At 720, in response to the request communication, a response communication (e.g., response communication 176B) can be generated, wherein the response communication can comprise an identifier/VIN of the receiving system, GPS location of the receiver system, a second timestamp, an inference of the location of the requesting system (as determined from the receiving system using the first timestamp), an image/data (e.g., image/data 151A-n which the receiving system can use to navigate based on), and suchlike (e.g., per FIG. 4).

At 730, the response communication can be transmitted to the requesting system (e.g., vehicle 102), to be locally processed at the requesting system.

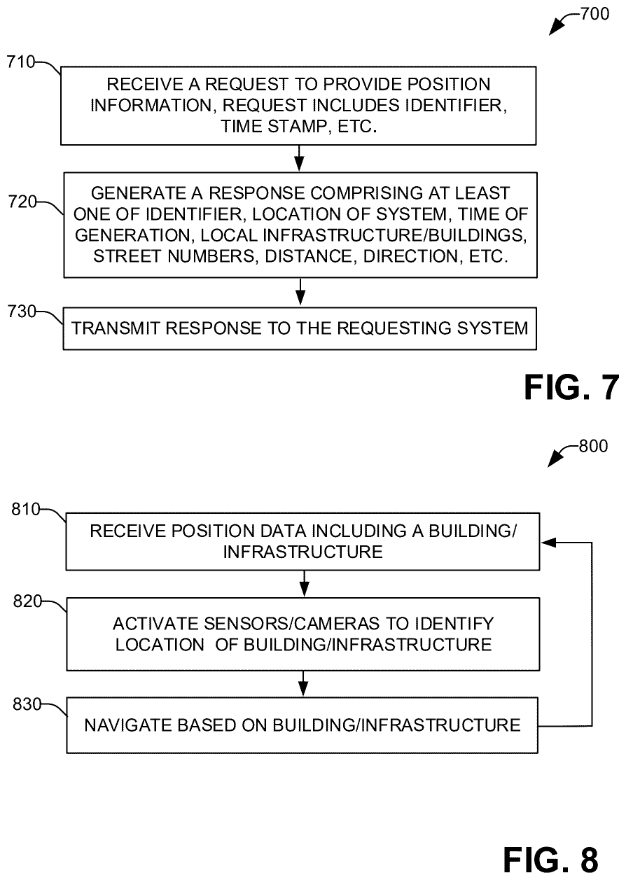

FIG. 8 presents a flow diagram 800 for a computer-implemented method for navigating a vehicle based on an identified structure, in accordance with at least one embodiment.

At 810, a communication (e.g., a response communication 176B) can be received at a vehicle (e.g., vehicle 102). The communication can include an image (e.g., images/data 151B) and positioning information (e.g., Pb1-n) regarding a structure/building (e.g., building 220A-n) located in the vicinity of the vehicle. The communication can be received from any entity (e.g., vehicle 270A-n, a mobile device 280A-n, an intelligent traffic signal 216A-n, a node 240A-n/242A-n, a device having a location application 290A-n implemented thereon, and suchlike) configured to interact with, and provide position information to, the vehicle.

At 820, cameras/sensors (e.g., cameras/sensors 150A-n) on the vehicle can be activated to identify the location of the building/infrastructure, e.g., relative to a position of the vehicle. Sensors can include a position sensor configured to determine a distance between the vehicle and the building/infrastructure.

At 830, with the location of/distance to the building/infrastructure identified, the vehicle (e.g., the navigation system 110) can utilize the GPS location of the building/infrastructure as a foundation for navigating the vehicle.

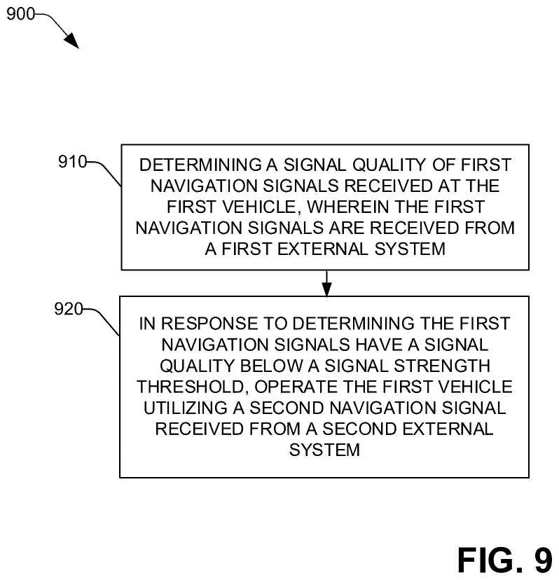

FIG. 9 illustrates a block flow diagram for a process 900 associated with implementing a second navigation signal in the event of a first navigation signal is below strength, in accordance with an embodiment.

At 910, the process 900 can comprise a system (e.g., navigation system 110), located on a first vehicle (e.g., vehicle 102) operating in at least a partially autonomous manner. The system can comprise a memory that stores computer executable components and a processor that executes the computer executable components stored in the memory. The computer executable components can comprise a signal component (e.g., signal component 130) configured to determine a signal quality of first navigation signals (e.g., signals 190A-n with position data 192A-n) received at the first vehicle, wherein the first navigation signals are received from a first external system (e.g., external system 195A-n).

At 920, the computer executable components can further comprise a navigation component configured to, in response to determining, by the signal component, the first navigation signals have a signal quality below a signal strength threshold, operate the first vehicle utilizing a second navigation signal received from a second external system.

### 9. AI/ML Considerations

As mentioned, various processes 179A-n can be configured to determine information, make predictions, etc., regarding detecting loss of first positioning data-n 192A-n and supplementing with second positioning data 197A-n, images/data 151A-n, and communications 176A-n. As previously mentioned, processes 179A-n can include AI, ML, and reasoning techniques/technologies that employ probabilistic and/or statistical-based analysis to prognose or infer an action that a user desires to be automatically performed. The various embodiments presented herein can utilize various ML-based schemes for carrying out various aspects thereof, e.g., position determination of vehicle 102, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In the various embodiments presented herein, the navigation system 110, and included components, can obtain position data and imagery (e.g., position data 192A-n and 197A-n, images/data 151A-n, and suchlike) from the external systems 191A-n and 195A-n, and cameras/sensors 150A-n, from which the navigation component 115 can be configured to determine/infer the location of vehicle 102. The processes 179A-n can include AI, ML, and reasoning techniques/technologies that employ probabilistic and/or statistical-based analysis to prognose or infer an action that a user desires to be automatically performed. The various embodiments presented herein can utilize various ML-based schemes for carrying out various aspects thereof, e.g., identifying street infrastructure (e.g., signs 215A-n, building numbers 221A-n, building signs 222A-n, and suchlike), identifying positioning data in communications (e.g., from traffic signals 216A-n, vehicles 270A-n, internet nodes 240A-n, mesh-network nodes 242A-n, mobile devices 280A-n, and suchlike), instructing other systems to assist with location prediction (e.g., per communications 176A-n) as previously mentioned herein, can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., inferring a location Px1-n of vehicle 102, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing similarity between images/data 151A-n received from external systems 195A-n and the ability of the navigation system 110 to identify location, distance, etc., of the one or more structures depicted in the imag-n/data 151A-n, ability for navigation system 110 to determine, with a desired level of accuracy, distance to buildings 220A-n, vehicles 270A-n, current location, and suchlike, and suchlike). For example, SVM's are configured via a learning or training phase within a classifier constructor and feature selection module. Thus, the classifier(s) can be used to automatically learn and perform a number of functions, including but not limited to determining according to predetermined criteria, e.g., position of vehicle 120, position of, distance to, other structures/buildings 220A-n, vehicles 270A-n, and suchlike.

As described supra, inferences can be made, and operations performed, based on numerous pieces of information. For example, information/data (e.g., images/data 151A-n) regarding position of, distance to, other structures/buildings 220A-n, vehicles 270A-n, utilizing timestamps 198A-n to infer position/distance, to determine whether vehicle 102 is in condition for autonomous driving/self-navigating driving, and suchlike.

### Example Applications and Use

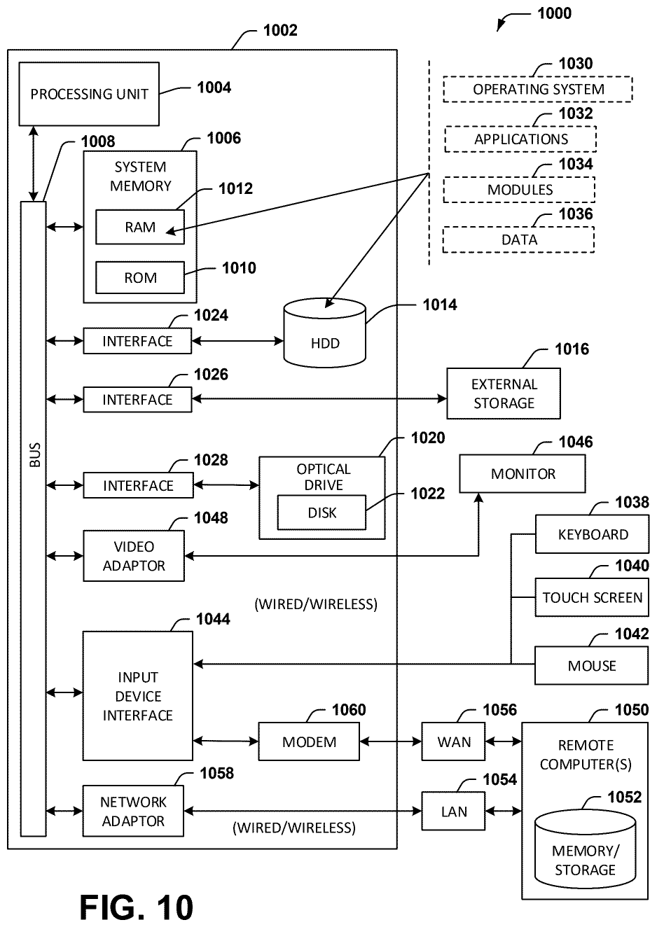

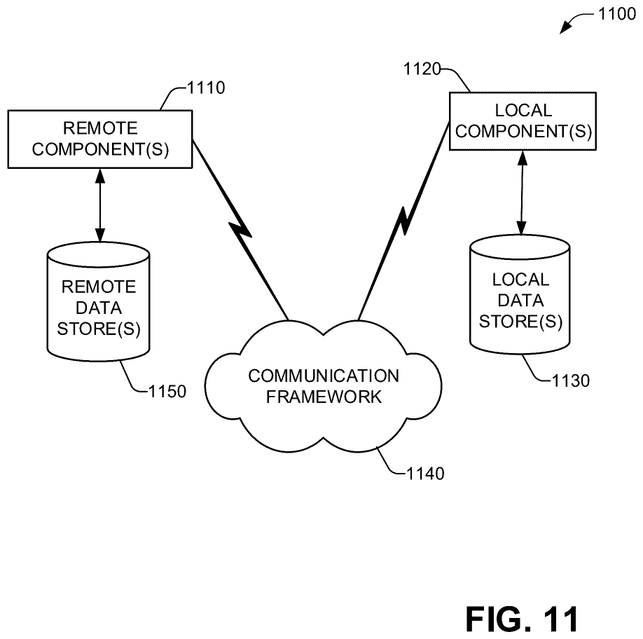

Turning next to FIGS. 10 and 11, a detailed description is provided of additional context for the one or more embodiments described herein with FIGS. 1-9.

In order to provide additional context for various embodiments described herein, FIG. 10 and the following discussion are intended to provide a brief, general description of a suitable computing environment 1000 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 11, an illustrative cloud computing environment 1100 is depicted. FIG. 11 is a schematic block diagram of a computing environment 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate / use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings.

Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses.

Clause 1. A system, located on a first vehicle operating in at least a partially autonomous manner, comprising: a memory that stores computer executable components; and a processor that executes the computer executable components stored in the memory, wherein the computer executable components comprise: a signal component configured to determine a signal quality of first navigation signals received at the first vehicle, wherein the first navigation signals are received from a first external system; and a navigation component configured to, in response to determining, by the signal component, the first navigation signals have a signal quality below a signal strength threshold, operate the first vehicle utilizing a second navigation signal received from a second external system.

Clause 2. The system of any preceding clause, wherein the second external system is located onboard a second vehicle, a mobile device, street infrastructure, an internet node, or a mesh-network node.

Clause 3. The system of any preceding clause, wherein the first external system is a global positioning system (GPS) utilizing GPS signaling technology and the second external system utilizes signaling technology comprising any of BLUETOOTH®, cellular technology, 3G cellular technology, 4G cellular technology, 5G cellular technology, internet technology, ethernet technology, ultra-wideband, DECAWAVE®, IEEE 802.15.4a standard-based technology, Wi-Fi technology, Radio Frequency Identification technology, short-range communication technology, or near field communication radio technology.

Clause 4. The system of any preceding clause, further comprising a location component further configured to: in response to the determination of the first navigation signals have a signal quality below the signal strength threshold, generate a request communication comprising a request for the second external system to provide at least one position relating to a location of the first vehicle.

Clause 5. The system of any preceding clause, wherein the signal component is further configured to transmit the request communication to the second external system.

Clause 6. The system of any preceding clause, wherein the signal quality of the first navigation signals being below the signal strength threshold is a function of reduction in signal strength of the first navigation signals due to the first vehicle operating in proximity to one or more buildings.

Clause 7. The system of any preceding clause, wherein the second navigation signal includes a location of the first vehicle, and the first vehicle is operating in an autonomous manner.

Clause 8. The system of any preceding clause, wherein the second navigation signal includes a timestamp identifying when the second navigation signal was transmitted and a location of a second vehicle, wherein the second external navigation system is located onboard the second vehicle.

Clause 9. The system of any preceding clause, further comprising a location component configured to: determine a distance from the second vehicle, based on a time difference between the timestamp and a time at which the second navigation signal was received at the first vehicle; and based on the location of the second vehicle and the distance from the second vehicle, a location of the first vehicle.

Clause 10. The system of any preceding clause, wherein the second navigation signal includes an image and position data of a building proximate to the first vehicle.

Clause 11. The system of any preceding clause further comprising a location component configured to: identify the location of the building in the image; determine a distance from the building to the first vehicle; and determine a location of the first vehicle, based on the location of the building and the determined distance between the first vehicle and the building.

Clause 12. A computer-implemented method comprising: determining, by a device comprising a processor located on a first vehicle, signal quality of first signals received at the first vehicle from a first external system is below a signal quality threshold for acceptable risk of operation of the vehicle; and switching, by the device, navigation of the vehicle from operation with the first data received from the first external system to operation with second signals comprising second data received from a second external system.

Clause 13. The computer-implemented method of any preceding clause, wherein the first external system is a global positioning system (GPS) comprising at least one satellite, and the second external system is located onboard a second vehicle communicatively coupled to the first vehicle.

Clause 14. The computer-implemented method of any preceding clause, further comprising generating, by the device, a request communication, for the second external system to provide at least one position relating to a location of the first vehicle; and transmitting, by the device, the request communication to the second vehicle.

Clause 15. The computer-implemented method of any preceding clause, further comprising: receiving, by the device, a first response communication, wherein the response communication comprises at least one of a position of the second vehicle, a position of the first vehicle, a time stamp, a direction of the second vehicle, a direction of the first vehicle, or an image of a structure proximate to the first vehicle.

Clause 16. The computer-implemented method of any preceding clause, further comprising: navigating, by the device, the first vehicle, based on at least one of the position of the second vehicle, the position of the first vehicle, the time stamp, the direction of the second vehicle, the direction of the first vehicle, or the image of a structure proximate to the first vehicle.

Clause 17. A computer program product comprising a computer readable storage medium having program instructions embodied therewith, the program instructions executable by a processor to cause the processor to: monitor signal strength of first signals received at a first vehicle operating in an autonomous manner, wherein the first signals are received from a first external system and are utilized for navigation of the vehicle; determine a drop in the signal strength of the first signals from a first signal strength to a second signal strength, wherein the first signal strength is acceptable for the autonomous operation of the first vehicle based on the first signals and the second signal strength is below a threshold acceptable for the autonomous operation of the first vehicle based on the first signals; and switch navigation of the first vehicle based on a second signal, wherein the second signal is sourced from a second external system, wherein the first external system is a global positioning system and the second external system is located on a second vehicle communicatively coupled to the first vehicle.

Clause 18. The computer program product of any preceding clause, wherein the second signal includes content comprising at least one of a position of the second vehicle, a position of the first vehicle, a time stamp, a direction of the second vehicle, a direction of the first vehicle, or an image of a structure proximate to the first vehicle.

Clause 19: The computer program product of any preceding clause, wherein the program instructions are further executable by the processor to cause the processor to determine a position of the first vehicle based on the content of the second signal, and navigate the first vehicle based on the determined position of the first vehicle.

Clause 20: The computer program product of any preceding clause, wherein the program instructions are further executable by the processor to cause the processor to: receive a third signal, wherein the third signal is received from one of an intelligent traffic control system, an internet node, a second vehicle, or a mobile device; and further navigate the first vehicle based on content in the third signal.

In various cases, any suitable combination of clauses 1-11 can be implemented.

In various cases, any suitable combination of clauses 12-16 can be implemented.

In various cases, any suitable combination of clauses 17-20 can be implemented.

What is claimed is:

1. A system, located on a first vehicle operating in at least a partially autonomous manner, comprising:
a memory that stores computer executable components; and
a processor that executes the computer executable components stored in the memory, wherein the computer executable components comprise:
a signal component configured to determine a signal quality of first navigation signals received at the first vehicle, wherein the first navigation signals are received from a first external system; and
a navigation component configured to, in response to determining, by the signal component, the first navigation signals have a signal quality below a signal strength threshold, operate the first vehicle utilizing a second navigation signal received from a second external system.

2. The system of claim 1, wherein the second external system is located onboard a second vehicle, a mobile device, street infrastructure, an internet node, or a mesh-network node.

3. The system of claim 1, wherein the first external system is a global positioning system (GPS) utilizing GPS signaling technology and the second external system utilizes signaling technology comprising any of BLUETOOTH®, cellular technology, 3G cellular technology, 4G cellular technology, 5G cellular technology, internet technology, ethernet technology, ultra-wideband, DECAWAVE®, IEEE 802.15.4a standard-based technology, Wi-Fi technology, Radio Frequency Identification technology, short-range communication technology, or near field communication radio technology.

4. The system of claim 1, further comprising a location component further configured to:
in response to the determination of the first navigation signals have a signal quality below the signal strength threshold, generate a request communication comprising a request for the second external system to provide at least one position relating to a location of the first vehicle.

5. The system of claim 4, wherein the signal component is further configured to transmit the request communication to the second external system.

6. The system of claim 1, wherein the signal quality of the first navigation signals being below the signal strength threshold is a function of reduction in signal strength of the first navigation signals due to the first vehicle operating in proximity to one or more buildings.

7. The system of claim 1, wherein the second navigation signal includes a location of the first vehicle, and the first vehicle is operating in an autonomous manner.

8. The system of claim 1, wherein the second navigation signal includes a timestamp identifying when the second navigation signal was transmitted and a location of a second vehicle, wherein the second external navigation system is located onboard the second vehicle.

9. The system of claim 8, further comprising a location component configured to:
determine a distance from the second vehicle, based on a time difference between the timestamp and a time at which the second navigation signal was received at the first vehicle; and
based on the location of the second vehicle and the distance from the second vehicle, a location of the first vehicle.

10. The system of claim 1, wherein the second navigation signal includes an image and position data of a building proximate to the first vehicle.

11. The system of claim 10, further comprising a location component configured to:
identify the location of the building in the image;
determine a distance from the building to the first vehicle; and
determine a location of the first vehicle, based on the location of the building and the determined distance between the first vehicle and the building.

12. A computer-implemented method comprising:
determining, by a device comprising a processor located on a first vehicle, signal quality of first signals received at the first vehicle from a first external system is below a signal quality threshold for acceptable risk of operation of the vehicle; and
switching, by the device, navigation of the vehicle from operation with the first data received from the first external system to operation with second signals comprising second data received from a second external system.

13. The computer-implemented method of claim 12, wherein the first external system is a global positioning system (GPS) comprising at least one satellite, and the second external system is located onboard a second vehicle communicatively coupled to the first vehicle.

14. The computer-implemented method of claim 12, further comprising:
generating, by the device, a request communication, for the second external system to provide at least one position relating to a location of the first vehicle; and
transmitting, by the device, the request communication to the second vehicle.

15. The computer-implemented method of claim 14, further comprising:
receiving, by the device, a first response communication, wherein the response communication comprises at least one of a position of the second vehicle, a position of the first vehicle, a time stamp, a direction of the second vehicle, a direction of the first vehicle, or an image of a structure proximate to the first vehicle.

16. The computer-implemented method of claim 15, further comprising:
navigating, by the device, the first vehicle, based on at least one of the position of the second vehicle, the position of the first vehicle, the time stamp, the direction of the second vehicle, the direction of the first vehicle, or the image of a structure proximate to the first vehicle.

17. A computer program product comprising a computer readable storage medium having program instructions embodied therewith, the program instructions executable by a processor to cause the processor to:
monitor signal strength of first signals received at a first vehicle operating in an autonomous manner, wherein the first signals are received from a first external system and are utilized for navigation of the vehicle;
determine a drop in the signal strength of the first signals from a first signal strength to a second signal strength, wherein the first signal strength is acceptable for the autonomous operation of the first vehicle based on the first signals and the second signal strength is below a threshold acceptable for the autonomous operation of the first vehicle based on the first signals; and
switch navigation of the first vehicle based on a second signal, wherein the second signal is sourced from a second external system, wherein the first external system is a global positioning system and the second external system is located on a second vehicle communicatively coupled to the first vehicle.

18. The computer program product of claim 17, wherein the second signal includes content comprising at least one of a position of the second vehicle, a position of the first vehicle, a time stamp, a direction of the second vehicle, a direction of the first vehicle, or an image of a structure proximate to the first vehicle.

19. The computer program product of claim 17, wherein the program instructions are further executable by the processor to cause the processor to:
determine a position of the first vehicle based on the content of the second signal; and
navigate the first vehicle based on the determined position of the first vehicle.

20. The computer program product of claim 17, wherein the program instructions are further executable by the processor to cause the processor to:
receive a third signal, wherein the third signal is received from one of an intelligent traffic control system, an internet node, a second vehicle, or a mobile device; and
further navigate the first vehicle based on content in the third signal.
